(19) United States
(12) Patent Application Publication
(10) Pub. No.: US 2016/0239552 A1
(43) Pub. Date: Aug. 18, 2016

(54) Data Display System

(71) Applicant: HITACHI, LTD., Tokyo (JP)

(72) Inventors: Takayuki UCHIDA, Tokyo (JP); Tomoaki HIRUTA, Tokyo (JP); Shigetoshi SAKIMURA, Tokyo (JP); Shinya YUDA, Tokyo (JP); Takahiro FUJISHIRO, Tokyo (JP)

(21) Appl. No.: 15/025,939

(22) PCT Filed: Oct. 29, 2014
(86) PCT No.: PCT/JP2014/078794

§ 371 Date: Mar. 30, 2016

(30) Foreign Application Priority Data
Oct. 1, 2013 (JP) 2013-206659

(51) Int. Cl. G06F 17/30; G06F 11/30; G06F 11/34; G06T 11/20; G08B 21/18

(52) U.S. Cl. CPC G06F 17/30554; G06T 11/206; G08B 21/187; G06F 17/30598; G06F 17/30327; G06F 11/3409; G06F 11/3013

(57) ABSTRACT

Times in association with a portion of data designated by an input device from a graph indicating distribution of data of a certain item are divided into plural groups based on the respective time intervals, data relating to desired items included in time ranges respectively regulated by the plural groups are searched from a storage device, and time waveforms of data relating to the desired items are created for each of the groups based on the search results. With this configuration, around the time of generating a portion of data included in a set of data relating to a certain item, aspects of temporal changes of data of a certain item or other items can be easily recognized.

### TECHNICAL FIELD

The present invention relates to a data display system that displays a temporal change of data relating to a certain item.

### BACKGROUND ART

In order to cause machinery such as a gas engine, an elevator, or mining and construction machinery to continuously operate, a maintenance operation of machinery is necessary. One of the technologies which is effective as a maintenance operation is a method of collecting sensor data (detected value) of plural sensors attached to respective portions of machinery, performing disorder diagnosis of the machinery from the collected sensor data, and performing cause analysis thereof when there is a disorder.

As a method of diagnosing a disorder using this technique, there is a method of expressing distribution of sensor data of machinery or occurrence frequency with a graph such as a scatter diagram or a histogram and examining a disorder of the machinery based on an outlier which is greatly deviated from other values in the graph. In this method, when an outlier occurs, it is assumed that a disorder is generated in the machinery, but it is necessary to specify a cause of the disorder by inspecting what is the actual cause of generation of the outlier. In order to specify the cause of the generation of the outlier, it is necessary to analyze temporal changes of sensor data, when the outlier occurs. However, in order to obtain a time waveform when the outlier occurs from a histogram or a scatter diagram, an operation of specifying time of the generation of a desired outlier and reading a time waveform of the generation time is necessary. If this operation is performed at each time of inspecting an outlier, there is a concern in that the efficiency of the inspection greatly decreases.

Examples of a data display device in which this problem is solved include JP-A-7-282277. In the literature, among a generation number of defects A to E and a total number of the defects of machinery on a predetermined date (for example, May 16), a ratio of occupying respective defects A to E is displayed on a screen with a pareto graph, and an analyst is caused to select the defects A to E that are desired to be displayed in time series of the generation number for a predetermined period. Also, based on only a simple operation of selection by an analyst, time series of the generation number of the selected defects for a predetermined period are displayed with a bar graph (trend chart). A horizontal axis in the bar graph indicates date, and a predetermined date (for example, May 1 to 16) including a predetermined date used in a pareto graph initially as the date is set. Accordingly, a pareto graph indicating cross-sectional characteristics in a time axis and a trend chart indicating characteristics in a time axis are organically bonded, and thus changes in time series of respective data can be easily recognized.

### CITATION LIST

### Patent Literature

PTL 1: JP-A-7-282277

### SUMMARY OF INVENTION

### Technical Problem

In the invention relating to the literature, a desired defect is selected from a bar graph (pareto graph) indicating the generation number of plural defects relating to the predetermined date, and a bar graph indicating the generation number of defects for several days including the predetermined day with respect to the selected defect is displayed. Therefore, changes in the generation numbers of the defects for each day are easily recognized. However, in case an outlier having a predetermined tendency in a period of time shorter than one day (for example, a short period of time from about several seconds to several hours) occurs, the changes may not be known by using graphs indicating the generation number of defects per day in many cases, and thus cause analysis becomes difficult. For example, according to defects, outliers are collectively generated for a short period of time, and outliers having the same tendency as the set of the outliers may be generated plural times with an interval. Therefore, the technique of the literature is not appropriate for the analysis of this type of defect.

In addition, in order to deal with outliers generated for a short period of time, it is considered to solve the problem described above by setting a unit of a horizontal axis (time axis) of a graph in time series of the generation number of defects in the technique above to a value less than one day (for example, minutes or hours). However, in this technique without change, an operation of specifying time at which the outlier is generated from the graph in time series and an operation of extracting and comparing the corresponding portion are required, and thus there is a concern in that a defect analysis operation may be delayed.

Further, the invention is not limited to the outliers exemplified above, but it is desirable to easily recognize an aspect of the temporal change of a portion of data (partial set) included in a set of data of a certain item that is associated with the time.

An object of the invention is to provide a data display system in which, in case a portion of data (partial set) included in a set of data relating to a certain item is generated for a short period of time from several seconds to several hours, an aspect of temporal changes of data relating to a certain item or other items around the time at which the portion of data is generated can be easily recognized.

### Solution to Problem

The invention includes plural items of means for solving the problem described above. An example thereof includes a data display system relating to the invention including a storage device that stores data relating to a plurality of items in association with respective times; a display device that displays a first graph indicating distribution of data relating to one item of the plurality of the items; an input device that designates a portion of data included in the distribution of the data indicated in the first graph; and a processing device that performs a first process of dividing times to be associated with the portion of data designated by the input device into a plurality of groups based on intervals of respective times, a second process of searching the data relating to desired items included in time ranges regulated by first and last times respectively included in the plurality of groups from the storage device, and a third process of displaying a second graph indicating temporal changes of the data relating to the desired items based on the search results on the display device for each of the plurality of time ranges.

### Advantageous Effects of Invention

According to the invention, by designating an item of which temporal changes around a time of generation of a portion (partial set) of a set of data relating to a certain item are desired to be known, it is possible to easily recognize an aspect of temporal changes around the generation time of data relating to the designated item. Accordingly, for example, also in case outliers are generated for a short period of time from several seconds to several hours, a time waveform graph is displayed for a short period of time around the generation time, and thus a main cause of the outliers can be analyzed from the waveform when the outliers are generated.

### BRIEF DESCRIPTION OF DRAWINGS

FIG. 1 is a diagram illustrating an object of the invention.

FIG. 2 is a diagram illustrating a subject of the invention.

FIG. 3 is a diagram illustrating a principle of the invention.

FIG. 4 is a diagram illustrating an entire configuration of a data display system relating to an embodiment of the invention.

FIG. 5 is a diagram illustrating a configuration of a table T1 stored in a sensor database 410.

FIG. 6 is a diagram illustrating a configuration of another table T7 stored in the sensor database 410.

FIG. 7 is a functional block diagram illustrating the data display system relating to the embodiment of the invention.

FIG. 8 is a sequence diagram illustrating a flow of processes performed in respective portions illustrated in FIG. 7.

FIG. 9 is a diagram illustrating a first selection screen displayed on a display device 440 in S505 of FIG. 8.

FIG. 10 is a diagram illustrating a configuration of a table T2 in which sensor data loaded in a storage device 450 from the table T1 in S510 of FIG. 8 is stored.

FIG. 11 is a scatter diagram created in S515 of FIG. 8.

FIG. 12 is a diagram illustrating a configuration of a table T3.

FIG. 13 is a diagram illustrating a configuration of a table T4.

FIG. 14 is a flowchart illustrating internal processes performed in S535 of FIG. 8.

FIG. 15 is a diagram illustrating a second selection screen displayed on a display device 440 in S538 of FIG. 8.

FIG. 16 is a diagram illustrating a configuration of a table T5.

FIG. 17 is a diagram illustrating a configuration of a table T6.

FIG. 18 is a flowchart illustrating an internal process S545_SUB performed in S545 of FIG. 8.

FIG. 19 is a flowchart illustrating a subroutine S545_SUB2 in an internal process illustrated in FIG. 18.

FIG. 20 is a diagram illustrating an example of a screen which is created in S550 and displayed in S555 of FIG. 8.

FIG. 21 is a diagram illustrating another example of a time waveform included in a screen displayed in S555 of FIG. 8.

### DESCRIPTION OF EMBODIMENTS

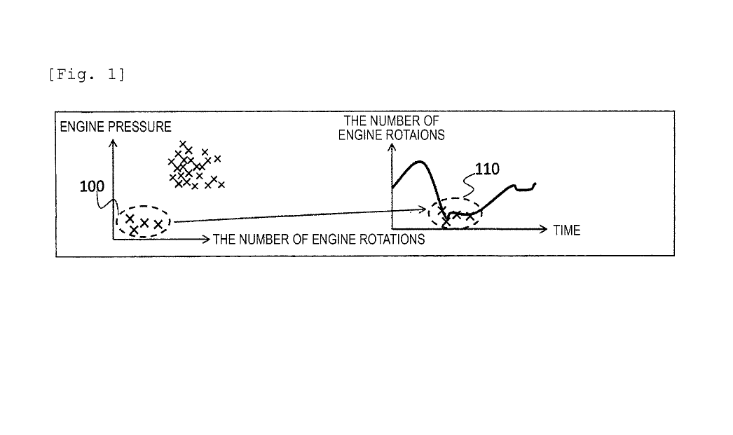

First, before an embodiment of the invention is described in detail, the basic concept of the embodiment described below is described. FIG. 1 is an example of a scatter diagram illustrating the relationship between engine pressure and the number of engine rotations which are detected in a predetermined period with a pressure sensor and a rotation number sensor in machinery in which an engine is installed. In the scatter diagram, a set 100 of an outlier exists as a partial set of sensor data. In this method, it is assumed that a disorder may occur in the machinery when an outlier occurs. As illustrated in an area 110 of a broken line in FIG. 1 in order to specify the cause of the generation of the outlier, sensor data (the number of engine rotations) with respect to the time when the outlier included in the set 100 occurs is analyzed based on the graph (time waveform) illustrating a temporal change of the sensor data.

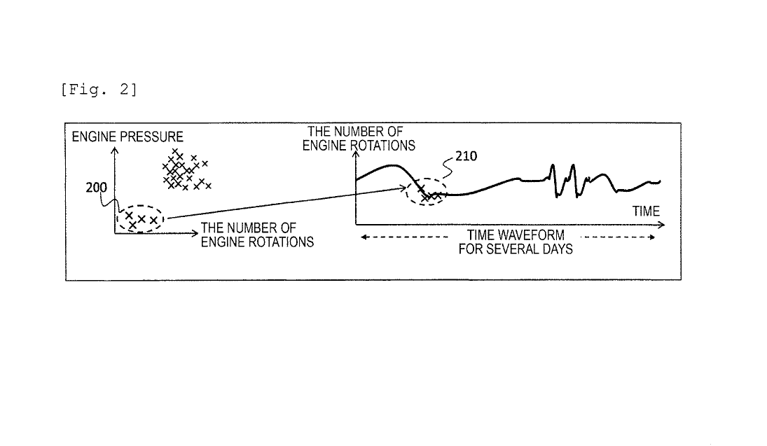

In the technique disclosed in JP-A-7-282277, a desired defect is selected from a bar graph (pareto graph) indicating the number of plural generated defects relating to the predetermined day, and a bar graph indicating the number of generated defects in several days including the corresponding predetermined day with respect to the selected defects is disclosed. However, as illustrated in FIG. 2, in case a set 200 of outliers is continued for a short period of time of several seconds to several minutes as in an area 210 of a broken line, even if a graph illustrating the number of generated defects per day is used, it is difficult or it is not possible to know the cause.

(1) Therefore, the data display system according to the present embodiment include a storage device (for example, a magnetic storage device such as a hard disk drive and a semiconductor memory such as a flash memory) in which data according to plural items (for example, engine pressure and the number of engine rotations) in association with respective times is stored, a display device (for example, a monitor) displaying a first graph (for example, a scatter diagram or a histogram) indicating the distribution of data relating to one item among the plural items, an input device (for example, a mouse, a keyboard, or a touch panel) to which a portion of data included in the distribution of the data illustrated in the first graph is designated, and a processing device (for example, CPU) that performs a first process of dividing the times associated with the portion of the data designated by the input device into plural groups based on intervals of respective times, a second process of searching data relating to the desired items (for example, the number of engine rotations) included in the time range designated in the first and last times respectively included in the corresponding plural groups from the storage device, and a third process of displaying a second graph (for example, time waveform of the number of engine rotations) indicating a temporal change of the data corresponding to the desired item based on the search result on the display device in each of the plural time ranges.

Accordingly, the times associated with the portion of the data designated by the input device can be automatically divided into plural groups based on the intervals of the respective times (for example, times which have intervals less than a predetermined threshold value are classified into the same group). Since a graph (second graph) indicating temporal changes of data relating to desired items with respect to the time range regulated by first and last times included in respective groups is created and displayed, aspects or tendencies of temporal changes of respective data relating to times at which a portion of the data designated on the first graph occurs can be easily recognized on the display device by using the input device. However, for example, even in a case where outliers are generated for a short period of time from several seconds to several hours, a time waveform of data of a desired item for the short period of time around the generation time is displayed, and thus a main cause of the outliers can be analyzed based on the time waveform.

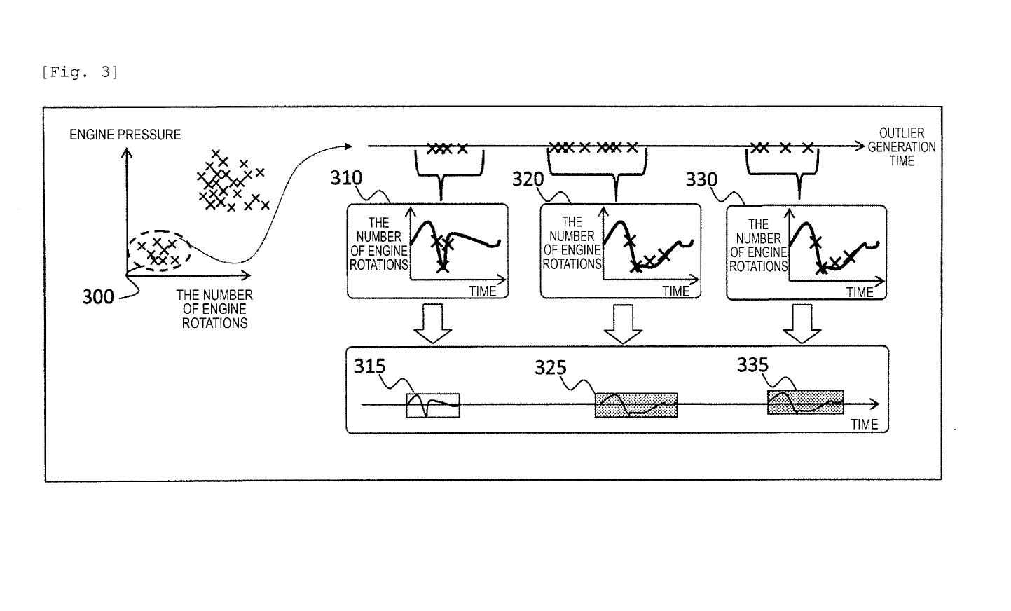

Further, actions and effects of the present embodiment with reference to an example illustrated in FIG. 3 are described as follows. In the example of FIG. 3, a scatter diagram (see a graph on the left end of FIG. 3) obtained by storing the number of engine rotations and the engine pressure which are values detected by a rotation number sensor and a pressure sensor in the storage device in association with the detection time and causing distribution of data of the number of engine rotations to be associated with the data of the engine pressure is displayed on the display device. If an analyst (operator) reads the scatter diagram and selects a set 300 of outliers via an input device such as a mouse, the processing device sorts times which correspond to the outliers in a time series order, and divides the times into plural groups based on intervals of respective times (see graphs on upper right of FIG. 3). Also, the processing device defines time ranges of respective groups based on first and last times included in the respective groups and searches the numbers of engine rotations included in the respective time ranges from the storage device. Further, the processing device creates temporal changes of the number of engine rotations for each of the time ranges (for each of the groups) based on the search result. In the examples of FIG. 3, the times sorted in a time series order are aggregated in types having close intervals and divided into three groups, and three time waveforms 310, 320, and 330 are created based on the data of the number of engine rotations included in the time ranges of the respective groups. Accordingly, the analyst can simply select a set of outliers in the data of the number of engine rotations on the first graph so as to obtain time waveforms automatically grouped based on the detection times of the selected outliers. Therefore, it is possible to easily recognize which changes are generated in the machinery at the time at which the outliers are generated.

(2) According to the present embodiment, it is preferable that a process of comparing shapes of second graphs for respective groups, grouping the graphs having similar shapes, and displaying the graphs on the display device is performed by the processing device. Accordingly, graphs having similar shapes among the plural second graphs are grouped and displayed to the analyst, and thus graphs that repeatedly occur among the plural second graphs can be easily specified. Therefore, the display screen is useful for assuming the cause of the generation of the data selected on the first graph.

With respect to the characteristics, in the example of FIG. 3, since the two waveforms 320 and 330 are similar to each other among the three time waveforms 310, 320, and 330 of the number of engine rotations based on the set of the outliers of the engine pressure and the number of engine rotations, backgrounds of the two waveforms and a background of the rest one waveform are displayed to be different from each other. That is, the background of a display waveform 315 relating to the waveform 310 is white, and backgrounds of display waveforms 325 and 335 relating to the waveforms 320 and 330 are hatched. For example, in this case, since two waveforms of the waveform 325 and the waveform 335 which are similar to each other are generated while one waveform of a waveform 315 is generated, the analyst can consider that the main cause of the outliers is related to the waveform 325 and the waveform 335. In addition, in view of the waveforms 325 and 335 and the generation time range thereof, the analyst can assume that the phenomenon occurred immediately after the start of the machinery, and the cause of the generation of the outliers is the engine pressure and the number of rotations which are lower than those in a normal operation of the machinery.

(3) In addition, before the first graph is displayed on the display device, a process of displaying a screen (first selection screen) for selecting an item for displaying the first graph among the plural items on the display device may be performed, and a process of displaying the distribution of data relating to the item selected through the screen (first selection screen) by the input device as the first graph may be performed by the processing device. Accordingly, the first graph relating to the desired item of the analyst can be displayed on the display device.

In addition, at this point, setting may be performed such that selecting types of the graphs to be displayed as the first graph and setting of the indexes required for the display of selected types the graphs can be performed on the first selection screen. For example, types of the graphs displayed as the first graph include a scatter diagram or a histogram. In the case of a scatter diagram, items for setting a vertical axis and a horizontal axis of the graph are required to be selectable on the first selection screen.

(4) In addition, before the second process, a process of (fourth process) displaying a screen (second selection screen) for selecting an item for which the data is searched from the storage device in the second process from the plural items is performed, and a process of searching data included in the plural time range among the data relating to the items selected in the fourth process as the second process from the storage device may be performed by the processing device.

Accordingly, an item to be displayed as a first graph and an item to be displayed as a second graph can be varied. For example, in case there are plural sensors measuring different states in the same portion of the machinery, if temporal changes of values detected by the plural sensors are respectively examined around the time at which outliers are generated, a cause that may not be proved only by a value detected by one sensor is proved in some cases. Specifically, in case a cause of outliers is not known even if a time waveform (second graph) with respect to the outliers of the engine temperature sensor is referred to, if a time waveform of a detected value of a pressure sensor for detecting engine pressure closely associated with an engine temperature is displayed, a cause of the outliers can be further searched. In addition, the “item” displayed in the second graph may be formed by displaying a selection screen (second display screen) each time such that one of the plural items is selected or may be set in advance.

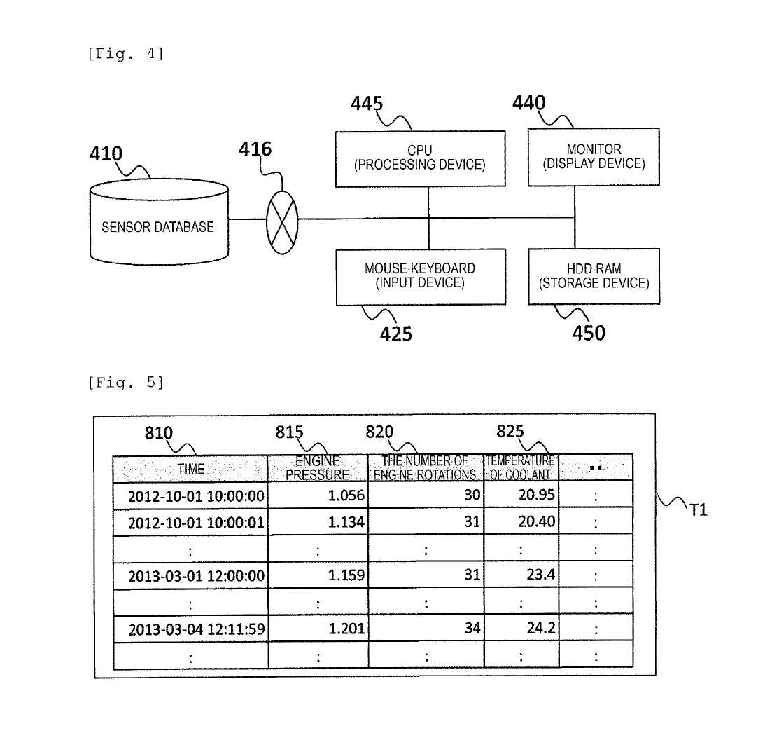

Hereinafter, the embodiment of the invention is described in detail by using the drawings. FIG. 4 is a diagram illustrating the entire configuration of the data display system according to the embodiment of the invention. The data display system illustrated in FIG. 4 includes a sensor database 410, a processing device 445, an input device 425, a storage device 450, and a display device 440.

The sensor database 410 is a database that stores sensor data (for example, engine pressure or the number of rotations) measured by various sensors installed in machinery such as railway or construction machinery.

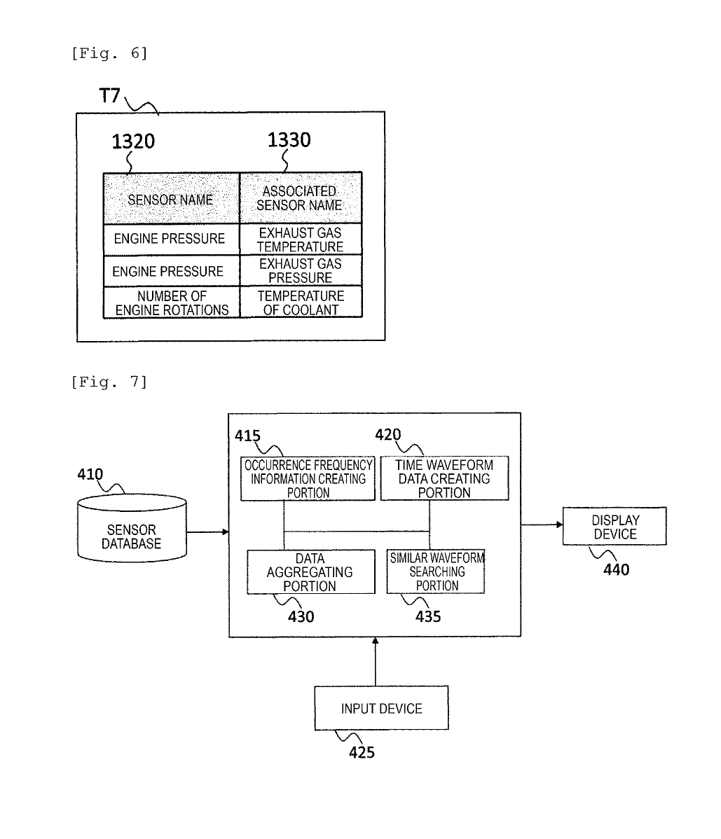

FIG. 5 is a diagram illustrating the configuration of a table T1 stored in the sensor database 410. In the table T1 illustrated in FIG. 5, detected values (sensor data) of the plural sensors are stored, plural sensor data 815, 820, and 825 and measuring times 810 thereof are stored in an associated manner, and sensor data in an arbitrary time range are configured in a searchable manner.

FIG. 6 is a diagram illustrating the configuration of a table T7 stored in the sensor database 410. The table T7 is a table in which information of a set of sensors which are closely associated with each other is stored. The closely associated sensors refer to a set of sensors measuring states of the same component, for example, a temperature sensor or a pressure sensor of an engine or a set of sensors that measures values interlocked to each other, such as an atmospheric temperature and an engine temperature.

For example, sensors of engine pressure on the first row of 1320 of T7 and an exhaust gas temperature of 1330 are sensors that indicate states of the same engine and are closely associated with each other. The cause of an outlier that may not be searched for with one sensor can be found out by examining waveforms of the closely associated sensors. For example, in case the cause of an outlier is not known even if a time waveform of a temperature sensor is referred to, the cause of the outlier can be further searched by subsequently referring to a time waveform of a pressure sensor closely associated with the temperature sensor. The closely associated sensor is decided based on hearing from a designer of the machinery or information of design specifications.

The processing device 445 is a device that includes a CPU or the like and performs an operation relating to various processes according to the present embodiment. The display device 440 includes a liquid crystal display or the like and displays a scatter diagram (first graph) or a time waveform (second graph) created by an occurrence frequency information creating portion 415 or a time waveform data creating portion 420 described below. The storage device 450 is a device that primarily and continuously stores various kinds of data together with programs for causing the processing device 445 to perform various processes, and includes a semiconductor memory such as ROM, RAM, and a flash memory or a magnetic storage device such as a hard disk drive. For example, tables T2 to T6 described below are stored in the storage device 450. The input device 425 includes a device such as a mouse, a keyboard, or a touch panel and enables a user to designate data or a sensor from a scatter diagram (first graph) or a table displayed on the display device 440.

In addition, the processing device 445, the display device 440, the storage device 450, the input device 425, and the database 410 may be installed in the same computer (calculator) or different computers. In the former case, all the devices 445, 440, 450, 425, and 410 or a computer in which functions of the devices (data display devices) are installed becomes the embodiment of the invention. Meanwhile, in the latter case, a computer in which the database 410 is installed and a computer in which the other devices are installed needs to be configured to perform transmission and reception of the data by being connected to each other via a network 416 such as a LAN or the Internet. Further, the computers may have a system configuration that performs a main process relating to a data display described below on the side of a server connected to the network and causes a client computer to instruct an operation to the server and acquire a corresponding calculation result. That is, the invention can exhibit the effect thereof, wherever the respective devices 445, 440, 450, 425, and 410 are installed.

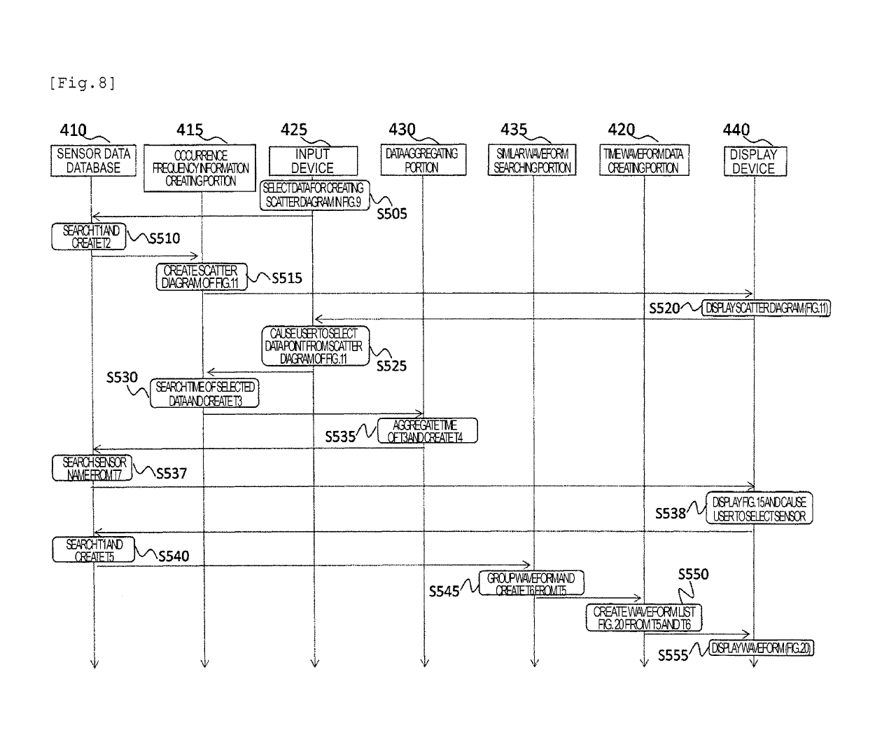

FIG. 7 is a functional block diagram of a data display system according to the embodiment of the invention. As illustrated in FIG. 7, the data display system according to the present embodiment functions as the occurrence frequency information creating portion 415, the time waveform data creating portion 420, a data aggregating portion 430, and a similar waveform searching portion 435.

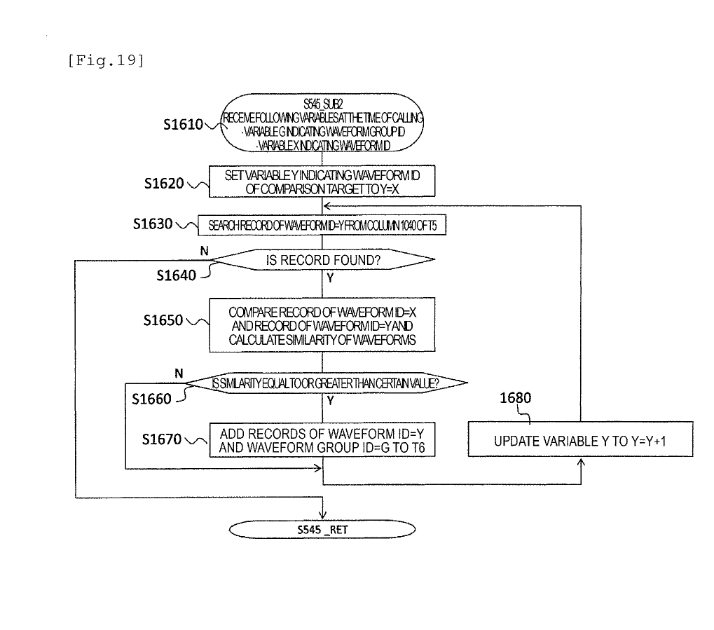

The occurrence frequency information creating portion 415 is a portion that reads sensor data of designated time ranges or types from the sensor database 410 and performs a process of creating a scatter diagram (first graph). The time waveform data creating portion 420 is a portion that reads sensor data of designated time ranges and types from the sensor database 410 and creates a time waveform (second graph). The data aggregating portion 430 is a portion that groups (aggregates) time information 913 to 918 in various portions of the table T3 and stores the resulting time ranges in the table T4. The contents of the detailed processes of the data aggregating portion 430 are described below with reference to FIG. 14. The similar waveform searching portion 435 is a portion that groups a similar time waveform of the sensor data from the table T5 and performs a process of storing the result in the table T6. Detailed processes of the similar waveform searching portion 435 are described below with reference to FIGS. 18 and 19.

Subsequently, with reference to FIG. 8, a flow of the process performed in the present embodiment is described. FIG. 8 is a sequence diagram illustrating a flow of the overall processes performed by respective portions illustrated in FIG. 7 and illustrates internal processes performed in the respective portions and data input and output between respective portions in a sequential order. In addition, FIG. 8 illustrates the overall flow of the processes performed in the present embodiment in steps of S505 to S555. The processes performed in the respective steps are described below.

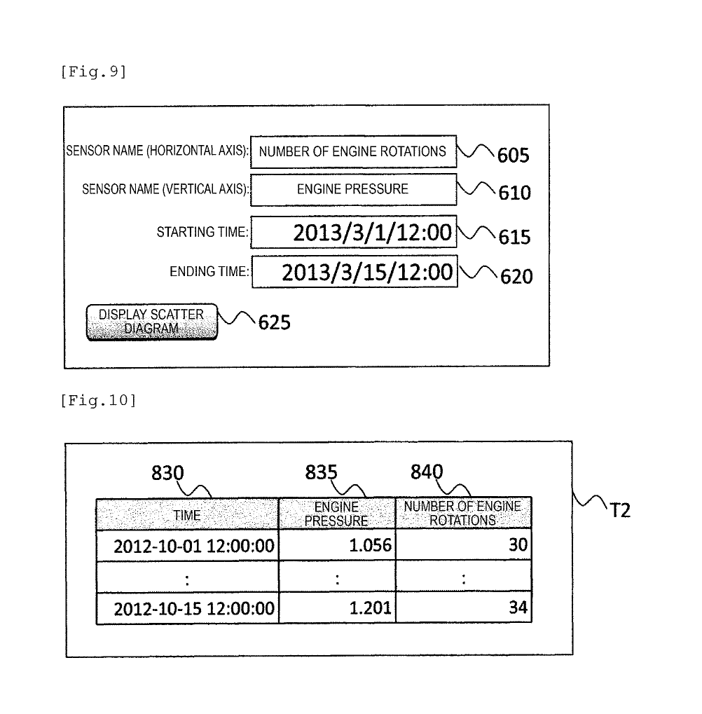

In S505, a screen (first selection screen) that enables a user (analyst) to select sensor data for creating a scatter diagram (first graph) is displayed on the display device 440. FIG. 9 is a diagram illustrating a first selection screen displayed on the display device 440 in S505. The first selection screen illustrated in FIG. 9 includes the sensor selecting portion 605 that selects a sensor to be displayed as a horizontal axis of a scatter diagram, a sensor selecting portion 610 that displays a sensor to be displayed as a vertical axis of a scatter diagram, a starting time setting portion 615 that decides a starting time in the measured time range of the sensor data displayed in the scatter diagram, and an ending time setting portion 620 that decides an ending time in the measured time range.

A method of selecting a sensor by the sensor selecting portions 605 and 610 may be a method of preparing a pull-down menu displaying a list of names of sensors in which sensor data are stored in the sensor database 410 and select a sensor from the pull-down menu. In addition, names of sensors may be directly input to the sensor selecting portions 605 and 610 with a keyboard. In addition, a method of setting the time by the starting time setting portion 615 and the ending time setting portion 620 includes a method of directly inputting times with a keyboard. If the names of the sensors and starting and ending times are completely input, when a user presses a button 625 for displaying a scatter diagram, the process proceeds to a process of S510 for creating a scatter diagram.

In S510, in the sensor data relating to the table T1 (FIG. 5) of the database 410, the sensor designated by the user and the sensor data of the time range are loaded in the storage device 450, in S505. FIG. 10 is a diagram illustrating a configuration of the table T2 storing sensor data loaded in the storage device 450 from the table T1 in S510. As illustrated in FIG. 10, the data loaded in the storage device 450 are stored in the table T2, in a set of two sensors (engine pressure and the number of engine rotations) 835 and 840 designated in S505 and sensor measurement times 830 corresponding thereto.

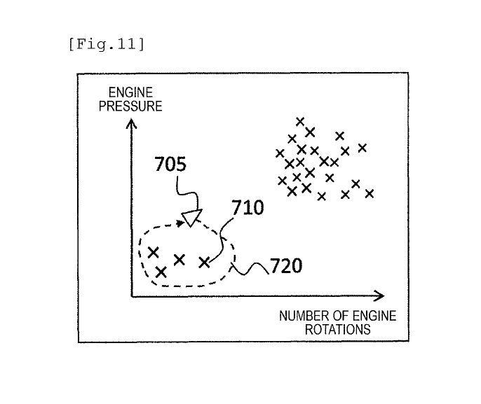

In S515, the occurrence frequency information creating portion 415 creates a scatter diagram from the table T2. FIG. 11 is a scatter diagram created in S515. In S515, specifically, values of the two sensors 835 and 840 from the first to last rows of the table T2 are illustrated on the scatter diagram of FIG. 11. In the examples of FIG. 11, values of the engine pressure 835 are illustrated on the vertical axis and the numbers of engine rotations 840 are illustrated on the horizontal axis, so as to create a scatter diagram.

In S520, the scatter diagram created in S515 is displayed on the display device 440 and is presented to the user. This process is automatically performed by causing the occurrence frequency information creating portion 415 to illustrate the scatter diagram on a liquid crystal display in S515.

In S525, a process of displaying a cursor 705 that can move on a screen by an operation of the input device 425 on a scatter diagram of S520 and causing the user to select plural data dots with the cursor 705 is performed. The user can move the cursor 705 along a track such as a dotted line 720 so as to select plural data dots at once surrounded by the track. The selected plural data dots are dots that the user desires to examine for the cause of the generation such as an outlier on the scatter diagram. In addition, another method of selecting the data dots on the scatter diagram is a method of drawing a rectangle having a diagonal line in a direction in which a mouse is dragged on a scatter diagram and selecting plural data dots existing inside the rectangle. In addition, well-known selection methods such as a method of clicking all data dots that the user desires to select with a mouse can be used.

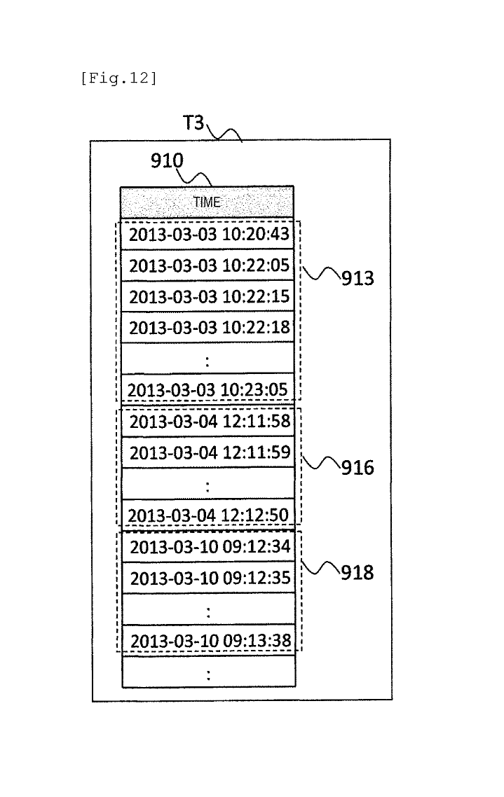

In S530, a process of searching a time (sensor measurement time) associated with plural data dots selected in S525 from the table T2 (FIG. 10), summarizing the results in the table T3, and storing the table T3 in the storage device 450 is performed. FIG. 12 is a diagram illustrating a configuration of the table T3. As illustrated in FIG. 12, the table T3 only includes time data. In order to create the table T3, the time 830 of the table T2 (FIG. 10) is searched by using values of the engine pressure and the number of engine rotations relating to the plural data dots selected on the scatter diagram of FIG. 11 as searching keys. The time list of the search result is stored in time 910 of the table T3 in a column order.

In S535, as preparation for creating a time waveform of sensor data to be selected in S538 later, plural time data stored in the table T3 is grouped according to the size of the interval of time. The time data included in the respective groups includes data indicating the earliest time and data indicating the latest time, but the times relating to the two groups of data determine the time ranges of the respective time waveforms displayed in S555.

In grouping of time waveforms (similar waveforms) having shapes similar to each other which is one of the characteristics of the present embodiment, it is necessary to extract a portion of time waveforms that is an analysis target among time waveforms of certain sensor data. In order to extract the portion of the time waveforms, it is necessary to determine the time ranges of the portion of the time waveforms. Therefore, according to the present embodiment, among time data stored in the table T3, the time ranges of the portion of the time waveform is decided by grouping (aggregating) types of which the times are close to each other. For example, in the table T3, the time data of 10:20:43 to 10:23:05 is grouped (aggregated) as the first group 913. The starting times and the ending times of the respective time ranges grouped are stored in the table T4.

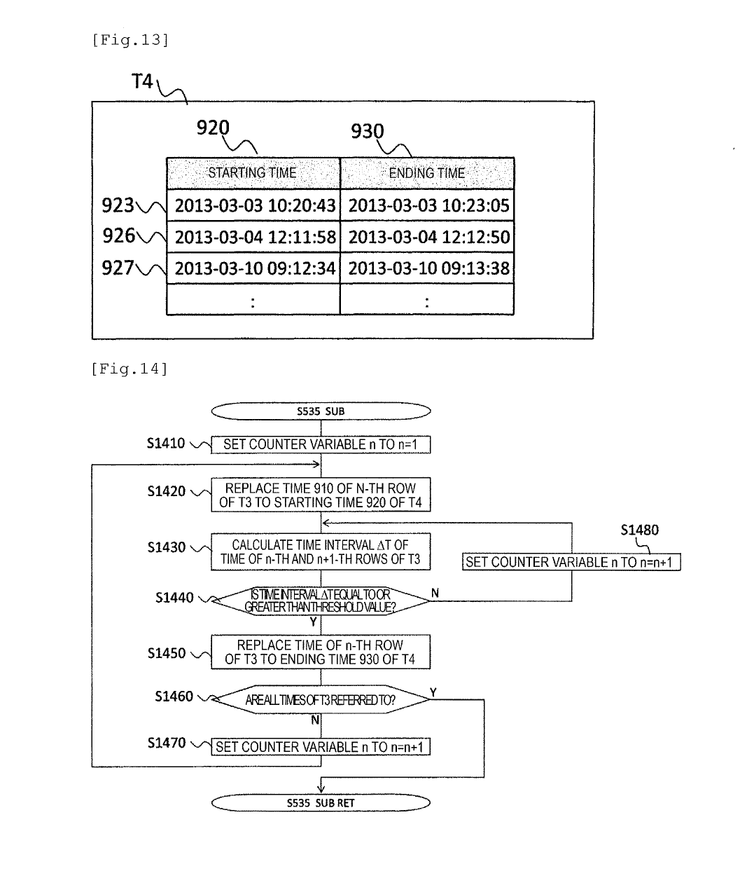

FIG. 13 is a diagram illustrating the configuration of the table T4. As illustrated in FIG. 13, sets of starting times 920 and ending times 930 of respective groups are stored in the table T4. Data stored in a first row 923 of the table T4 indicate the time range of the first group 913 of the table T3. In the same manner as the case where the first group 913 is decided from the time data of the table T3, in case data having close data values (times) are grouping, techniques in the related art are used. For example, as the techniques in the related art, clustering in the data mining technology can be used. In the present embodiment, more simple examples are used. Specifically, a method in which, in case the time interval of the two time data adjacent to each other in the time data sorted in time series is equal to or less than the threshold value, the two time data are caused to be in the same group is used. Subsequently, this method is described by using FIG. 14. In addition, the threshold value of the time interval is determined when the present system is decided and is simply referred to as a threshold value according to the present embodiment.

FIG. 14 is a flowchart illustrating the internal process performed in S535 of FIG. 8. In other words, FIG. 14 illustrates a flow of grouping time information of the table T3 and storing the results thereof in the table T4. First, in S1410, a storage area of the counter variable n is prepared in the storage device 450. This counter variable n is a variable indicating the number of rows in the data of the table T3. The counter variable n starts from n=1 and n increases one by one until n reaches the row numerical value relating to the last row of the table T3.

In S1420, the n-th row time is read from the table T3 and is stored in the starting time 920 of the table T4. Specifically, in the case of n=1, data (2013 Mar. 3 10:20:43) relating to the first row of the table T3 are stored in the column 920 of the starting time on the first row 923 of the table T4.

In S1430, a time interval ΔT between the n-th row and the n+1-th row of the table T3 is calculated. For example, in the case of n=1, the first row and the second row of T3 become “2013 Mar. 3 10:20:43” and “2013 Mar. 3 10:22:05”, and thus the time interval ΔT between the both becomes 22 seconds.

In S1440, whether the time interval ΔT calculated in S1430 is equal to or greater than the threshold value determined at the time of designing the system is determined. If the time interval ΔT is equal to or greater than the threshold value, it is determined that the times in the n-th row and the n+1-th row of the table T3 are boundaries of the two time waveforms, and the process proceeds to S1450. Otherwise, if the time interval ΔT is less than the threshold value, it is considered that the times in the n-th row and the n+1-th row are times to be included in one time waveform, and the process proceeds to S1480 in order to continue the grouping process. For example, in case the threshold value is ten minutes, when the time interval ΔT is 22 seconds as described above, the time interval ΔT is smaller than the threshold value, and thus the process proceeds to S1480.

In S1480, the counter variable n is updated to n+1 in order to cause the time in the n-th row to be in the same group on the n−1-th row and refer to the subsequent time on the n+1-th row and the process returns to S1430.

In S1450, it is determined that the time on the n-th row is the boundary between the waveforms in S1440, and thus the time on the n-th row is stored in a column 930 of the ending time of the table T4 as the ending time of the waveform. For example, in the first group 913 of the table T3, the time when the time interval to the next time is equal to or greater than one day “2013 Mar. 3 10:23:05” becomes the ending time, and thus the corresponding time is stored in the column 930 on the first row 923 of the table T4.

In S1460, the determination process whether the ending condition is satisfied is performed. That is, whether the entire data of the table T3 are referred to in the processes of S1410 to S1450 until now is determined. If the entire data is referred to, the present routine is completed. Meanwhile, if the entire data of the table T3 are not referred to, the process proceeds to S1470.

In S1470, in order to find out a subsequent time waveform, the counter variable n is increased by only 1, and the process returns to S1420. In the above, the subroutine of S535 is completed, and subsequently the process proceeds to S537 of FIG. 8.

In S537, the process of deciding a candidate of a sensor for displaying the time waveform (second graph) in S555 is performed. According to the present embodiment, a sensor relating to two sensors (the sensors set in the vertical axis and the horizontal axis of the scatter diagram) selected at the time of creating the scatter diagram (FIG. 11) in S505 is searched from the table T7 (FIG. 6) stored in the sensor database 410, and the sensor relating to the search result becomes a sensor candidate. Specifically, the engine pressure and the number of engine rotations which is the vertical axis and the horizontal axis of the scatter diagram in FIG. 11 are used as searching keys, a row including the engine pressure or the number of engine rotations is searched from the first column of the table T7, the name of the sensor stored in the second column on the corresponding row is acquired as a relating sensor. From the table T7 illustrated in FIG. 6, as the sensor relating to the engine pressure and the number of engine rotations, three sensors for exhaust gas temperature, exhaust gas pressure, and coolant are acquired. Also, in addition to the three sensors, five sensors including the two sensors (the engine pressure and the number of engine rotations) used as the searching keys become candidates of the sensors for displaying the time waveform in S555.

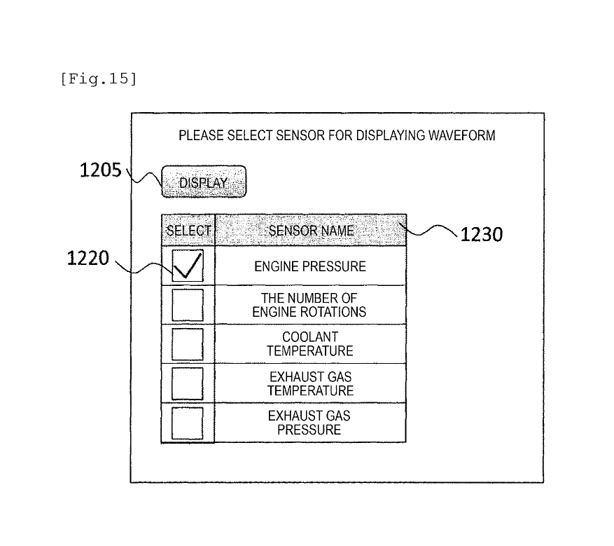

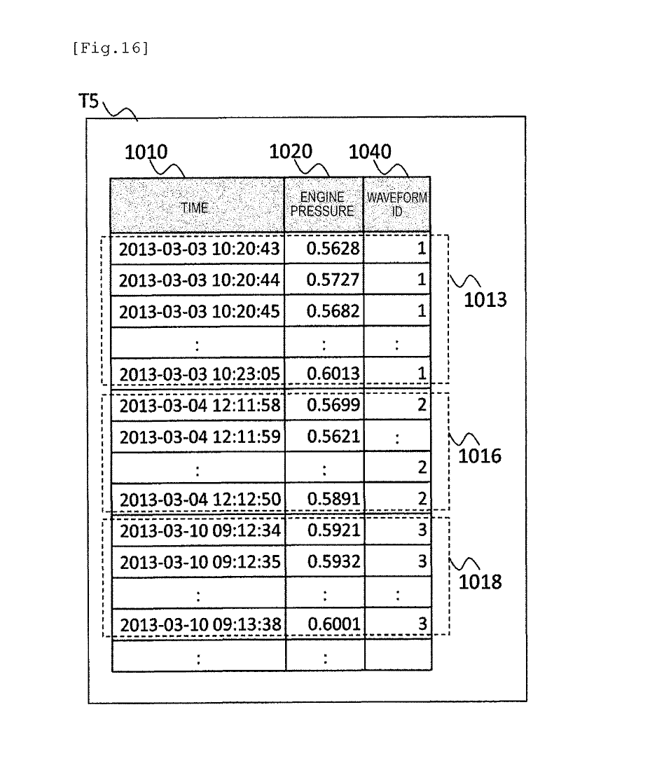

In S538, among the sensor candidates decided in S537, a screen (second selection screen) for causing the user to select only one sensor for displaying the time waveform (second graph) is displayed on the display device 440. FIG. 15 is a diagram illustrating the second selection screen displayed on the display device 440 in S538. On the second selection screen as illustrated in FIG. 15, a table having a column 1230 storing names of the sensors acquired in S537 are displayed. On the first column of the corresponding table, checkboxes 1220 are provided such that the user can input a check in a corresponding checkboxes relating to a sensor of which a time waveform is desired to be displayed. If the selection of the sensor is completed via the checkboxes 1220, the display button 1205 is activated, and if the display button 1205 is pressed by the user, the process proceeds to S540. Here, as illustrated in FIG. 15, the description is continued assuming a case where the engine pressure is selected in S538.

In S540, a process of loading the sensor data selected in S538 from the database 410 and creating a new table T5 is performed. FIG. 16 is a diagram illustrating a configuration of the table T5. According to the present embodiment, the “engine pressure” is selected in S538, and thus the engine pressure is loaded from the table T1 (FIG. 5) of the sensor database 410. The data to be loaded is decided based on the table T4 (FIG. 13). Specifically, sensor data included in the time range (the ending time 930 from the starting time 920 in respective groups) regulated in the table T4 is loaded.

According to the present embodiment, as illustrated in FIG. 5, engine pressure detected per one second is stored in the table T1, and thus engine pressure data per one second included in the respective time ranges regulated in the table T4 are stored in the table T5. For example, first, the engine pressure data in the time range (2013 Mar. 3 10:20:43 to 2013 Mar. 3 10:23:05) relating to the first row 923 of the table T4 is loaded from the table T1. The loaded sensor data 1013 is stored in the table T5 in time series.

The data (integer) stored in the waveform ID of a third column 1040 of the table T5 is identical to the ID of the group in S535, and applied to the respective sensor data when being stored in the table T5. Waveform IDs 1040 in the table T5 are numbered to 1, 2, 3, and the like sequentially from 1. That is, a waveform ID of the sensor data 1013 in the time range relating to the first row 923 of the table T4 is stored as 1 in the table T5, a waveform ID of the sensor data 1016 in the time range relating to a second row 926 of the table T4 is stored as 2 in the table T5, and the waveform ID of the sensor data 1018 in the time range relating to a third row 927 is stored as 3 in the table T5. Hereinafter, values of the waveform IDs are increased one by one, and the sensor data are stored in the table T5 in the same manner. The waveform ID is used in the group having a waveform similar to that in a subsequent step of S545.

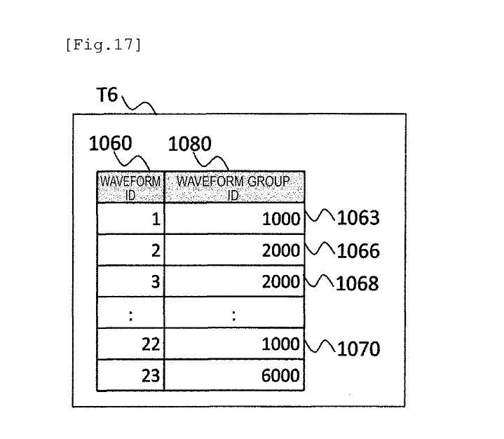

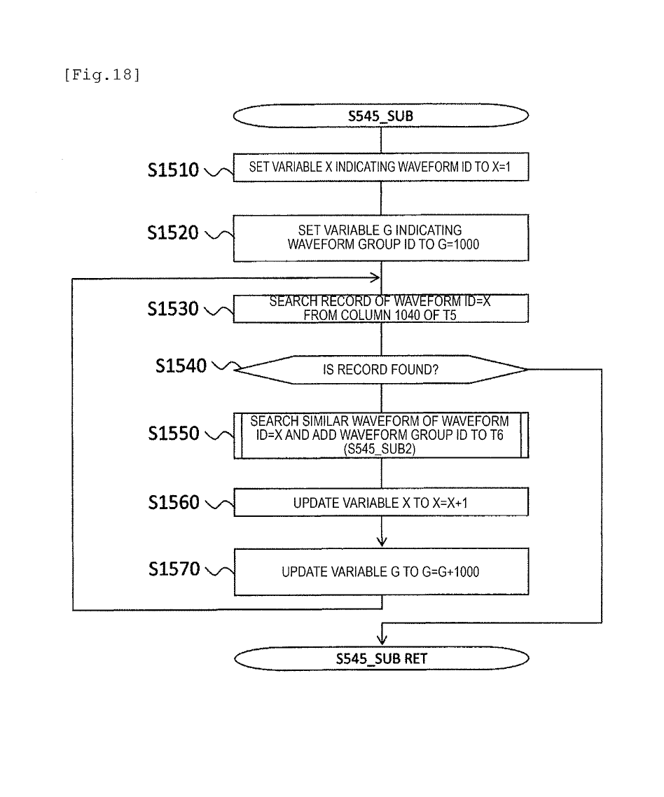

In S545, a process of grouping time waveforms (second graph) created with the sensor data 1013, 1016, 1018, and the like to which the same waveform ID is applied in the table T5 according to shapes thereof is performed. The results of the groups in the time waveform are stored in the table T6. FIG. 17 is a diagram illustrating a configuration of the table T6. In a first column 1060 of the table T6, waveform IDs are stored, and IDs of the waveform groups which are grouping results of the waveforms are stored in a second column 1080. In the example of FIG. 17, a waveform of waveform ID=1 belongs to a waveform group ID 1000, and the waveform IDs 2 and 3 belong to a waveform group ID 2000.

Subsequently, a specific order of grouping waveforms performed in performed in S545 is described below as a subroutine of S545 with reference to FIGS. 18 and 19. FIG. 18 is a flowchart of an internal process S545_SUB performed in S545 of FIG. 8, and FIG. 19 is a flowchart of a subroutine S545_SUB2 (a process of grouping similar waveforms) in an internal process indicated in FIG. 18.

In S1510 of FIG. 18, in order to designate the waveform ID of the table T5, an area of a variable X indicating a waveform ID is secured in the storage device 450. An initial value of the variable X of the waveform ID is set to be 1 as the minimum value.

In S1520, an area of a variable G indicating the waveform group ID is secured in the storage device 450. The variable G indicates a waveform group ID to which the waveform having the similar shape belongs. The initial value of the variable G is set to be 1000 in the present embodiment.

In S1530, a waveform ID of a third column 1040 is searched by using the value of the variable X from the table T5 (FIG. 16) as a searching key, and the sensor data of the waveform ID of X is found out. For example, if the variable X is 1, the sensor data 1013 in the waveform ID of 1 in the table T5 becomes the sensor data to be found.

In S1540, whether a record is found out in S1530 is determined. If one or more rows of sensor data are found from the table T5 in S1530, the process proceeds to S1550. If sensor data are not found, it is determined that searching of all waveform IDs is completed, so as to complete the present subroutine.

In S1550, existence or non-existence of the time waveform (similar waveform) having a similar shape to the shape of the time waveform having the waveform ID of X found in S1530 is searched from the table T5. In case a similar waveform exists, a process of grouping the both is performed. For example, if the variable X is 1 (that is, the waveform ID is 1), a time waveform of the sensor data 1013 and a time waveform of the sensor data (for example, the sensor data 1016 and 1018) relating to another waveform ID are compared with each other. In case a similar waveform exists, in the table T6, 1000 (a value of the variable G) which is the same waveform group ID with respect to the waveform ID of the time waveform similar to the time waveform of the sensor data 1013 is stored. Here, a subroutine which corresponds to a grouping process and which is illustrated in FIG. 19 is called.

The process content of the subroutine (S545_SUB2) of FIG. 19 is described. In S1610 of FIG. 19, the variable G indicating the waveform group ID and the variable X indicating the waveform ID are received from the subroutine of the calling source in FIG. 18. If the calling is performed for the first time, the variable X is 1 and the variable G is 1000. In the steps subsequent to S1620, the time waveform of the engine pressure similar to the waveform having the waveform ID of X is found from the table T5 and is stored in the table T6 by linking to the value of the variable G.

In S1620, an area of the variable Y indicating the waveform ID of the time waveform to be compared with the time waveform having the waveform ID of X in shapes is secured in the storage device 450. The initial value of the variable Y has the same value as the variable X. If the variable X is 1, Y also becomes 1. In the subroutine of FIG. 19, the value of the variable X caused to be constant, and values of the waveform ID of Y of the comparison target are increased to 1, 2, 3, and the like and are compared with the waveform ID of X, such that the similar waveforms are checked.

In S1630, the sensor data having the waveform ID of Y is searched from the table T5. If Y is 1, 1013 of the table T5 is searched. In addition, since the initial value of Y is X, the waveform having the waveform ID of X is also searched, but the waveform group ID of the waveform having the waveform ID of X also needs to be stored in the table T6 as a grouping result, and thus the corresponding process becomes a correct process.

In S1640, whether the record is found in S1630 is determined. If the sensor data having the waveform ID of Y is found out, the process proceeds to S1650. If the sensor data is not found out, it is determined that all waveforms are completely compared, the present subroutine is completed, and the process proceeds to S1560 of FIG. 18.

In S1650, a process of comparing a waveform having the waveform ID of X and a waveform having the waveform ID of Y with each other and determining whether the both are similar to each other is performed. According to the present embodiment, the determination whether the waveforms having the waveform IDs of X and Y are similar to each other is decided based on the size of the similarity S (X, Y) defined as below. S (X, Y) is calculated in Formula A below from Dx (k) (k=1, 2, 3, . . . , Nx) which are the sensor data of the waveform ID of X and Dy (k) (k=1, 2, 3, . . . , Ny) which are the sensor data of the waveform ID of Y. However, in Formula A below, considering the case where there is a difference between the numbers of data dots included in Dx (k) and Dy (k), m=MIN (Nx, Ny) is set. That is, among Nx and Ny which are the numbers of the sensor data dots of Dx (k) and Dy(k), one having the smaller number of data dots is set to be m. In addition, the correspondence is only an example of the correspondence of a case where there is a difference between the numbers of the data dots, and well-known correspondence such as causing the numbers of the data dots of the both to be the same by adding the data dots to the time waveform having the smaller number of data dots is possible. In addition, at the time of comparing the two waveforms, if the time ranges of the both are greatly different from each other, it is possible to determine that the both waveforms are not similar or to compare the both by scaling the waveform such that the time range of one waveform is matched with that of the other waveform.

$$S ( X , Y ) = \frac{1}{{\sum }_{k = 1}^{m} {\{ Dx ( k ) - Dy ( k ) \}}^{2}} \qquad ( A )$$

In the example of the table T5 of FIG. 16, Dx (k) and Dy(k) are sensor values of the engine pressure. If the waveform ID of X is 1, Dx (k) is a numerical value of the engine pressure included in the sensor data 1013, and Dx (1)=0.5628 and Dx (2)=0.5727 are satisfied. Also, if the waveform ID of Y of the comparison target is 2, Dy (k) is a numerical value of the engine pressure included in the sensor data 1016, Dy (1)=0.5699 and Dy(2)=0.5621 are satisfied. If the similarity S (X, Y) between the waveforms having the waveform IDs of X and Y is calculated from Dx (k) and Dy (k), the process proceeds to S1660.

In S1660, if the similarity S (X, Y) calculated in S1650 is greater than a threshold value S0 decided at the time of designing the present system, it is determined that the waveforms having the waveform IDs of X and Y are similar to each other, and the process proceeds to S1670. Otherwise, the process proceeds to S1680. In addition, the threshold value S0 may be changed afterwards.

In S1670, the IDs of the waveforms which are determined to have high similarity in S1660 are stored in the table T6 (FIG. 17). Specifically, the value of the waveform ID of Y is stored as the waveform ID in the first column 1060 of the table T6, the value of the variable G is stored as the waveform group ID in the same row of the second column 1080. The variable G is a value of the waveform group ID received from the calling source in S1610. For example, in case the waveform having the waveform ID of 2 and the waveform having the waveform ID of 3 in the table T5 are similar to each other and the value of the variable G (waveform group ID) at the time of calculating the similarity between the waveforms of the both is 2000, the data is stored as in the second and third rows of the table T6.

Since the comparison between the waveforms having the waveform IDs of X and Y is completed with this, the value of the variable Y is increased by 1 in S1680, and comparison of a subsequent waveform is prepared. For example, if comparison between waveforms having X of 1 and Y of 1 are completed, Y is set to be 2 and comparison between the waveforms having the waveform ID of 1 and the waveform ID of 2 is prepared. Thereafter, the process returns to S1630.

With the above, the subroutine of FIG. 19 and S1550 of FIG. 18 are completed, and the process proceeds to S1560 of FIG. 18.

In S1560 of FIG. 18, the variable X indicating the waveform ID of the waveform comparison source is increased by 1, and the searching of a subsequent similar waveform is prepared. For example, if the searching of the similar waveform of which the waveform ID of X is 1 is completed, the waveform ID of X is updated to 2, and the preparation for searching the subsequent similar waveform is performed.

In S1570, the variable G indicating the waveform group ID is increased by 1000, the waveform group ID to which the next similar waveform belongs to is updated, and the process returns to S1530. For example, if searching of the similar waveform having the waveform ID of 1 is completed, the waveform group ID of G=1000 is updated to G=2000. In addition, according to the present embodiment, if the value of the variable is increased 1000 by 1000, the increasing amount may be an arbitrary value.

In the above, the subroutine of FIG. 18 and the process of S545 of FIG. 8 are completed, and the process proceeds to S550.

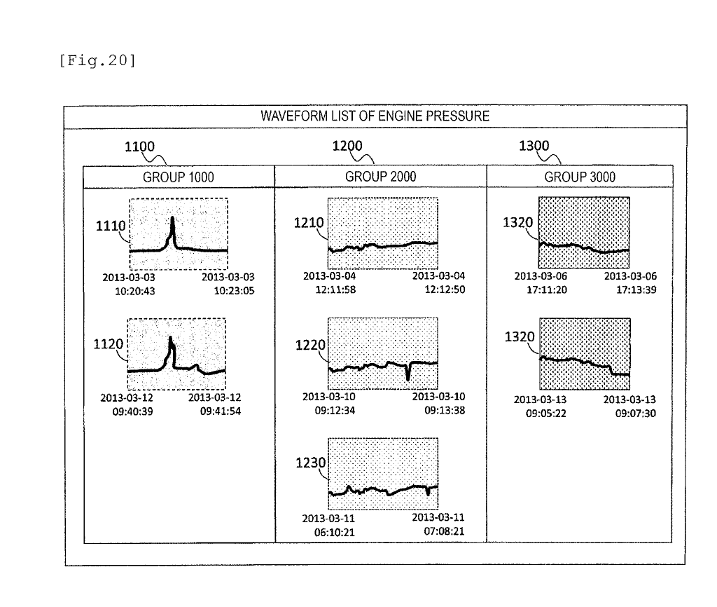

In S550, a screen indicating the time waveform (second graph) of the sensor data selected in S538 (FIG. 15) and the grouping result based on the table T5 (FIG. 16) and the table T6 (FIG. 17) is created. FIG. 20 is a diagram illustrating an example of the screen which is created in S550 and is displayed in S555. In the example of FIG. 20, a case where there are three waveform group IDs (1000, 2000, and 3000) stored in the table T6 is indicated, the inside of the screen is divided into three display portions 1100, 1200, and 1300 by matching the number of the waveform group IDs. A display portion 1100 is a portion indicating waveforms belonging to the waveform group ID of 1000, and the waveforms (second graph) having the waveform IDs of 1 and 22 belonging to the waveform group ID of 1000 in the table T6 are displayed as the waveforms 1110 and 1120, respectively. The sensor data for displaying the waveforms 1110 and 1120 can be searched from the table T5 by using the waveform IDs of 1 and 22 as searching keys.

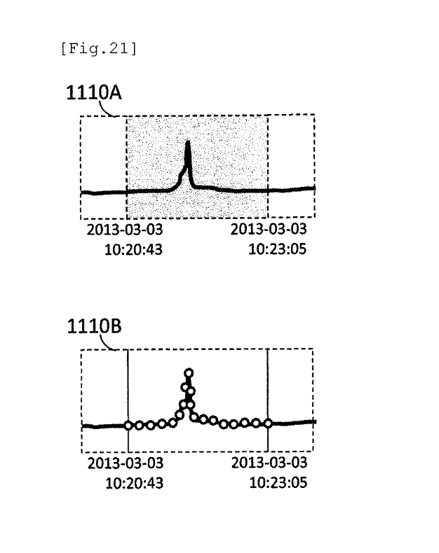

In addition, as the sensor data searched at the time of creating the time waveforms of the respective waveform IDs, not only the sensor data having the respective waveform IDs in the table T5, that is, the sensor data included in the time range defined in the table T4, and but also the sensor data included in the expanded time range which is obtained by expanding the corresponding time range by the time regulated before and after are added, such that the time waveform may be created. In this case, it is preferable to consider the display of the time waveform such that the time range defined in the table T4 and the time range in an expanded amount are distinguished. Specific examples of this type of the display include changing a background of a time waveform (see a waveform 1110A in FIG. 21) and drawing dots of only the sensor data included in the time range of the table T4 on the time waveform (see a waveform 1110B in FIG. 21). If the time of displaying the time waveform is expanded in this manner, it is possible to recognize how the sensor data are changed before and after the data selected on the scatter diagram (FIG. 11) such that analysis of the data can be performed. In addition, instead of the process above, it is possible to perform the process of displaying the time waveform of the sensor data in which the time range is expanded in the sequence therebefore.

Detailed description is omitted, since details thereof are the same as those of the display portion 1100, but the display portion 1200 is a portion indicating the waveforms belonging to the waveform group ID of 2000, and three waveforms 1210, 1220, and 1230 are displayed. A display portion 1300 is a portion indicating waveforms belonging to the waveform group ID of 3000, and the two waveforms 1310 and 1320 are displayed.

In addition, in case waveforms relating to all waveform group IDs stored in the table T6 cannot be displayed, waveforms of all group IDs can be caused to be displayed by forming a configuration of enabling a screen to be scrolled or to be transitioned to another screen. In addition, the screen may be formed such that only the number of waveform group IDs is displayed, the desired IDs are selected by clicking the IDs with a mouse or the like, and all waveforms belonging to the corresponding ID are displayed. That is, if the total number of the waveform group IDs (the number of groups) included in the table T6 and the shapes of the waveforms included in the respective groups can be checked, a method of displaying the respective waveforms is not particularly limited.

If the process of creating the screen is completed, the process proceeds to S555. In S555, FIG. 20 created in S550 is displayed on the display device 440 so as to be provided to the user. Accordingly, a series of processes illustrated in FIG. 8 is completed. In addition, incase a scatter diagram of other sensor data is desired to be displayed, the process returns to the initial S505. In case time waveforms of other sensor data are desired to be displayed though the selection of data dots on a scatter diagram is not changed, the process may return to S538.

According to the data display system configured as described above, if an item of which a temporal change around a portion of the generation time for a set of data relating to a certain item is desired to be known is designated, an aspect of the temporal change around the generation time of the data relating to the designated item can be easily recognized. Accordingly, for example, even in a case where an outlier is generated for a short period of time of several seconds to several hours, a time waveform graph for a short period of time around the generation time is displayed, such that a main cause of the outlier can be analyzed from the waveform when the outlier is generated.

In addition, the sequence of the respective processes used in FIGS. 8, 14, 18, 19, or the like is merely an example, and can be appropriately changed as long as the sequence is in the range in which the effect above can be exhibited.

In addition, in the above, a case where screens are transitioned in the sequence of FIGS. 9, 11, 15, and 20 is described, but in case a sensor that has to display a scatter diagram and a time waveform is designated in advance, FIGS. 9 and 15 can be omitted. In addition, in FIG. 11, after the data is selected in the cursor 705, a short cut operation which is designated in advance is performed with the input device 425 such as a mouse, a keyboard, and a touch panel, the selection of the sensor as illustrated in FIG. 15 is alternately performed, and the display of FIG. 15 can be omitted.

In addition, the scatter diagram is displayed as FIG. 11 in the above. However, another graph may be displayed as long as the graph is a graph for recognizing the tendency of the sensor data in the database 410, such as a histogram or a pareto graph. At this point, it is obvious that the screen of FIG. 9 is created such that a necessary index can be appropriately input required for regulating the graph displayed in FIG. 11.

In addition, in the above, an occasion in which a so-called outlier on FIG. 11 is selected, a trend of the outlier is recognized from a time waveform, and a cause of a disorder is investigated is described as an example. However, the invention is not limited thereto, and the invention is widely useful in an occasion in which, in case plural partial sets are recognized with respect to the distribution of data relating to a certain item, a change of certain data relating to the time at which the data included in the respective partial sets are detected is displayed, and the tendency of the data included in the partial set is visually recognized.

With respect to functions corresponding to the present system illustrated in FIG. 7, execution processes for exhibiting the corresponding functions, and the like, a portion or all of the functions and the execution processes may be realized by hardware (for example, designing logics for executing the respective functions with an integrated circuit). In addition, the configuration relating to the data display system may be a program (software) by which respective functions relating to the configuration of the corresponding system is realized by being read and executed by a processing device (for example, a CPU) are realized. For example, the information relating to the program may be stored in a semiconductor memory (a flash memory, an SSD, or the like), a magnetic storage device (a hard disk drive or the like), a storage medium (a magnetic disk, an optical disk, or the like), or the like.

In addition, in the description of the embodiment, control lines or information lines which are considered to be necessary in the description of the embodiment is provided. However, it is not considered that all control lines and all information lines which relate to the product are necessarily described. In reality, it may be considered that almost all configurations are connected to each other.

In addition, the invention is not limited to the embodiment described above, but various modification examples are included without departing from the gist of the invention. For example, the invention is not limited to include all configurations described in the embodiment described above, but includes an example in which a portion of the configurations is deleted.

### REFERENCE SIGNS LIST

410 . . . sensor database, 415 . . . occurrence frequency information creating portion, 420 . . . time waveform data creating portion, 425 . . . input device, 430 . . . data aggregating portion, 435 . . . similar waveform searching portion, 440 . . . display device, 445 . . . processing device, 450 . . . storage device, S . . . similarity

1.-11. (canceled)

12. A data display system comprising:
a storage device that stores data relating to a plurality of items in association with respective times;
a display device that displays a first graph indicating distribution of data relating to one item of the plurality of the items;
an input device that designates a portion of data included in the distribution of the data indicated in the first graph; and
a processing device that decides a plurality of time ranges for searching data of the storage device based on the time associated with the portion of the data designated by the input device, searches data included in the respective time ranges, that is, data relating to desired items among the plurality of items, from the storage device, and displays a second graph indicating temporal changes of the data based on results obtained by searching the data relating to the search results, on the display device for each of the time ranges.

13. The data display system according to claim 12,
wherein in order to display the second graph, the processing device performs:
a first process of dividing the times to be associated with the portion of data designated by the input device into a plurality of groups;
a second process of searching the data relating to the desired items included in the time ranges regulated by the times respectively included in the plurality of groups from the storage device; and
a third process of displaying the second graph indicating temporal changes of data relating to the desired items based on the search results on the display device for each of the plurality of time ranges.

14. The data display system according to claim 12,
wherein the processing device further performs a process of comparing shapes of the second graph for each of the plurality of the time ranges, grouping graphs having similar shapes, and displaying the graphs on the display device.

15. The data display system according to claim 13,
wherein, before the first graph is displayed on the display device, the processing device performs a process of displaying a first selection screen for selection of an item for displaying the first graph among the plurality of items on the display device and displaying distribution of the data relating to the item selected through the first selection screen with the input device as the first graph.

16. The data display system according to claim 13,
wherein the processing device performs:
a fourth process of displaying a second selection screen for selection of an item for which data is searched from the storage device in the second process among the plurality of items before the second process; and
a process of searching data included in the plurality of the time ranges among data relating to the items selected in the fourth process from the storage device, as the second process.

17. The data display system according to claim 12,
wherein a value designated as the portion of the data of the corresponding data from the distribution of the data indicated in the first graph by the input device is an outlier having a value deviated from other data.

18. The data display system according to claim 12,
wherein the storage device stores a detected value of a plurality of sensors installed in machinery as data relating to the plurality of items, and
sensor detected values relating to the plurality of sensors are respectively stored in association with the detection times.

19. The data display system according to claim 12,
wherein the first graph is a scatter diagram illustrated such that distribution of data relating to the one item corresponds to distribution of data relating to other items included in the plurality of items or a histogram illustrating distribution of data relating to the one item.

20. A data display device comprising:
a storage device that stores data relating to a plurality of items in association with respective times;
a display device that displays a first graph indicating distribution of data relating to one item of the plurality of the items;
an input device that designates a portion of data included in the distribution of the data indicated in the first graph; and
a processing device that performs a first process of dividing times to be associated with the portion of data designated by the input device into a plurality of groups based on intervals of respective times, a second process of searching the data relating to desired items included in time ranges regulated by first and last times respectively included in the plurality of groups from the storage device, and a third process of displaying a second graph indicating temporal changes of the data relating to the desired items based on the search results on the display device for each of the plurality of time ranges.

21. A data display method comprising:
a first step of creating a first graph indicating distribution of data relating to one item among the plurality of items, by using a storage device that stores data relating to a plurality of items in association with respective times;
a second step of designating a portion of data included in the distribution of the data indicated in the first graph;
a third step of dividing the times to be associated with the portion of data designated in the second step into a plurality of groups based on intervals of respective times;
a fourth step of searching data relating to desired items included in time ranges regulated by first and last times respectively included in the plurality of groups from the storage device; and
a fifth step of creating a second graph indicating temporal changes of data relating to the desired items based on the search result for each of the plurality of time ranges.

22. The data display method according to claim 21, further comprising:
a sixth step of comparing shapes of the second graph for each of the plurality of the time ranges created in the fifth step and grouping graphs having similar shapes.
